(19) United States
(12) Patent Application Publication
(10) Pub. No.: US 2009/0085921 A1
(43) Pub. Date: Apr. 2, 2009

(54) Populate Web-Based Content Based on Space Availability

(76) Inventors: Lydia Mai Do, Raleigh, NC (US); Fu Yi Li, Sudbury, MA (US); Pamela Ann Nesbitt, Tampa, FL (US); Lisa Anne Seacat, San Francisco, CA (US)

Correspondence Address: HAMILTON & TERRILE, LLP;IBM RSW, P.O. BOX 203518, AUSTIN, TX, 78720, US

(21) Appl. No.: 11/865,400

(22) Filed: Oct. 1, 2007

(51) Int. Cl. G06F 12/02

(52) U.S. Cl. 345/543

(57) ABSTRACT

A method, system and computer usable medium are disclosed for managing the display of content elements within a predetermined display area of a user interface. Content requests are submitted from a browser to a content server. In response, the content server acquires candidate content elements for display within the browser. A content element manager determines the dimensions of a target display area within the user interface (UI) of the browser. The content element manager then determines the space required to display each of the candidate content elements. Calculations are then performed to determine the maximum number of content elements that will fit within the dimensions of target display area. Once determined, the content elements are selected and displayed in the display area.

### BACKGROUND OF THE INVENTION

1. Field of the Invention

Embodiments of the disclosure relate in general to the field of computers and similar technologies, and in particular to software utilized in this field. Still more particularly, it relates to managing the display of content in a user interface.

2. Description of the Related Art

In recent years, it has become common to use the World Wide Web for the provision of a wide variety of information and content. Web servers using the Hypertext Transfer Protocol (HTTP), which manages the exchange of information with request-response cycles, provide web content, which can be either static or dynamic. Static content contains data from files stored at a server, while programs executing at the time an HTTP request is made construct dynamic content. For example, a client may submit a request for information to a server. The request may be for a static page, which has been created using the Hypertext Mark-up Language (HTML) or the Extensible Mark-up Language (XML). The request may also result in the generation of a dynamic Web page. These dynamic pages may result from the use of technologies such as Java Server Pages (JSP), Active Server Pages (ASP), PHP, or a request that a particular application (such as a servlet) be executed to generate a return page. The server, upon receiving such a request from the client, performs the necessary tasks to generate the return page, such as retrieving the requested page or application, executing as required, accessing databases if needed, establishing connections to other server, etc. When the server obtains the necessary information, the server transmits a response to the client, completing the request-response cycle.

The Web page presented to the client is often comprised of two or more content display areas, regardless of whether the page is static or dynamically generated. For example, it is common to have a horizontal content display area running as a banner across the top of the Web page. This banner area is typically used to display advertising content, but it can also used for other purposes, such as news updates. It has also become common for Web pages to have a vertical content display area, which generally appear as a column containing one or more content elements. These content elements may contain information related to other content displayed on the page or they may be links to other resources, such as associated Web pages or advertiser sites.

One current issue with displaying content elements is optimizing the number of elements that can be fitted within a given content display area. For example, a generated Web page may contain two content display areas. The first display area contains information while the second contains links to related information. The information contained in the first display area may only occupy half of the available display area on the user's screen, while links in the second display area may continue for several screen pages. One current approach to this issue is to make the dimensions of the second display area static and limit the maximum number of content elements that can be displayed. While this approach may be suitable for Web pages where the first display area is likewise static, it is less useful when the first display area is dynamic. As an example, the length of a dynamically generated first display area may extend for several screen pages, yet the second display area may only be displayed on the first screen page if its length is static. This becomes problematic when additional content elements are available but cannot be displayed due to space limitations caused by the static dimensions of the second display. Similarly, the dynamic narrowing of the width of the first display area can result in underutilized space appearing between the first and second display areas. In view of the foregoing, it would be advantageous to optimize the utilization of a content display area when displaying content elements.

### BRIEF SUMMARY OF THE INVENTION

The present invention includes, but is not limited to, a method, system, and computer-usable medium for managing the display of content elements within a predetermined display area of a user interface. In various embodiments, content requests are submitted from a browser to a content server. In response, the content server acquires candidate content elements for display within the browser. A content element manager determines the dimensions of a target display area within the user interface (UI) of the browser. The content element manager then determines the space required to display each of the candidate content elements. Calculations are then performed to determine the maximum number of content elements that will fit within the dimensions of target display area. Once determined, the content elements are selected and displayed in the display area.

In one embodiment, the amount of display space each of the plurality of content objects occupies is the same. In another embodiment, the amount of display space each of the plurality of content objects occupies is different. In different embodiments, at least one of the dimensions of the target display area is static. In other embodiments, at least one of the dimensions of the target display area may be dynamic. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 shows a simplified block diagram of a content element manager as implemented to optimize the display of content elements;

FIGS. 3a-f show a simplified browser user interface (UI) as implemented with a content element manager to optimize the display of content elements;

FIG. 4 shows a flowchart of a content element manager as implemented to optimize the display of content elements;

FIGS. 5a-b show a simplified browser UI as implemented with a content element manager to optimize the display of content elements in a static display area; and

FIGS. 6a-b show a simplified browser UI as implemented with a content element manager to optimize the display of content elements in a dynamic display area.

### DETAILED DESCRIPTION

A method, system and computer usable medium are disclosed for managing the display of content elements within a predetermined display area of a user interface. As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit”, “module”, or “system”. Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therein, either in baseband or as part of a carrier wave. The computer usable program code may be transmitted using any appropriate medium, including but not limited to the Internet, wireline, optical fiber cable, radio frequency (RF), etc.

Computer program code for carrying out operations of the present invention may be written in an object oriented programming language such as Java, Smalltalk, C++, or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

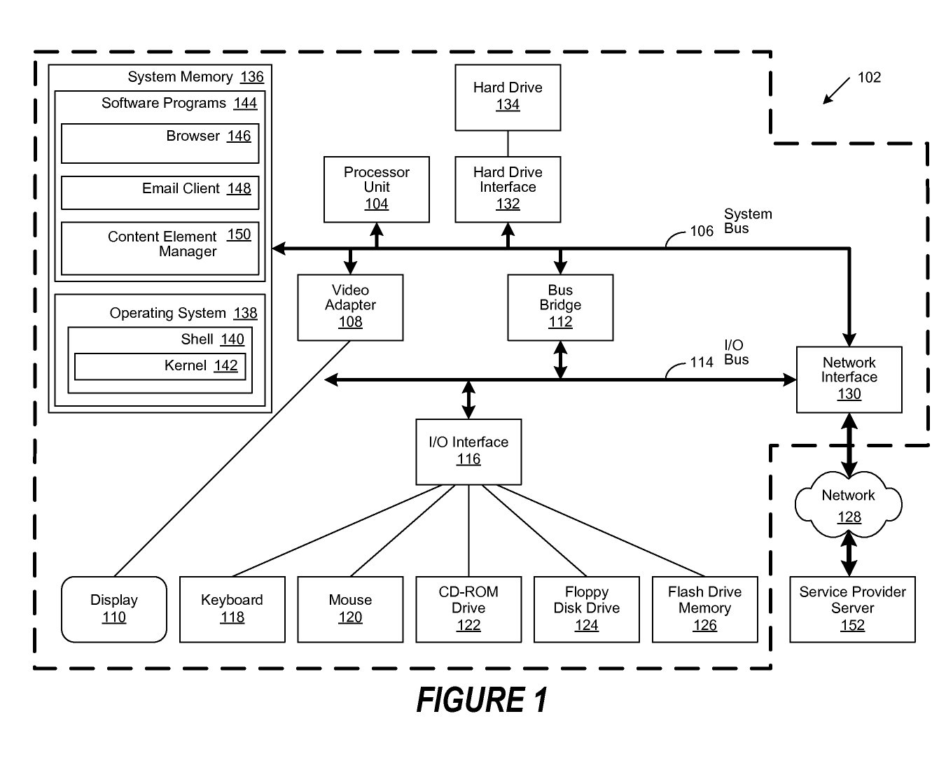

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy, and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management.

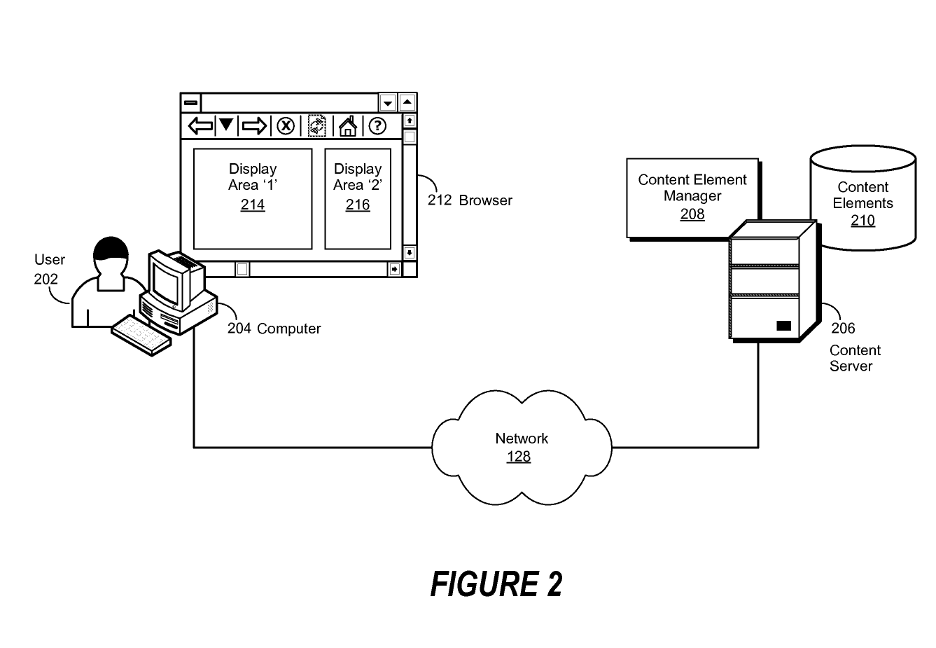

Software programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. Software programs 144 also include a content element manager content element manager 150. The content element manager 150 includes code for implementing the processes described in FIGS. 2 through 6 described hereinbelow. In one embodiment, client computer 102 is able to the download content element manager 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 shows a simplified block diagram of a content element manager as implemented in an embodiment of the invention to optimize the display of content elements. In various embodiments, a browser 212 is implemented on the computer 204 of user 202. The browser 212 initiates a communications session over network 128 with content server 206. Once the session is initiated, content requests are submitted by the browser 212 to the content server 206. In response, the content server 206 accesses content elements 210, which are then retrieved and sent for display in the browser 212. In one embodiment, information content is displayed in display area ‘1’ 214 and a plurality of related content elements, such as links to Web pages or advertisements, are displayed in display area ‘2’ 216 of the browser 212. In this and other embodiments, the content element manager 208 determines the dimensions of display area ‘2’ 216. Then the content element manager 208 determines the space required to display each content element 210. Calculations are then performed to determine the maximum number of content elements that will fit within the dimensions of display area ‘2’ 216. Once determined, the content elements are displayed in the display area ‘2’ 216 of browser 212.

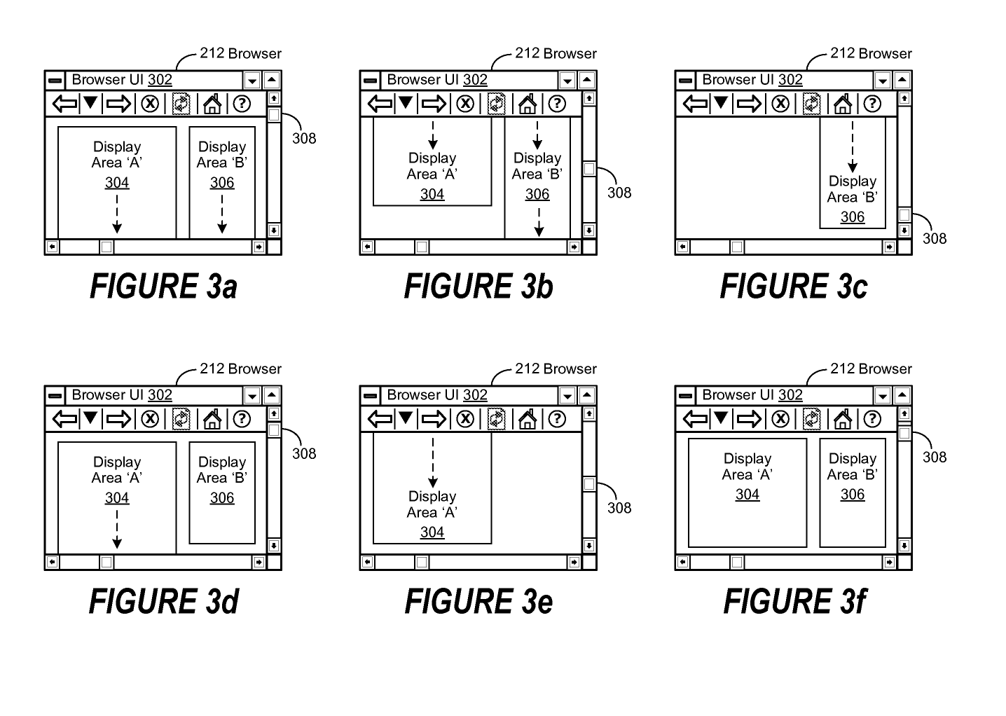

FIGS. 3a-f show a simplified user interface (UI) 302 of browser 212 as implemented with a content element manager to optimize the display of content elements. In this embodiment, the browser UI 302 comprises display area ‘A’ 304 and display area ‘B’ 306. As described in greater detail herein, content requests are typically submitted by the browser 212 to a content server. In response, the content server accesses content elements, which are then retrieved and sent for display within display area ‘A’ 304 and display area ‘B’ 306 in the browser UI 302.

In one embodiment, display area ‘A’ 304 is implemented as a primary information display area and display area ‘B’ 306 is implemented to display a plurality of content elements such as links to related Web pages or advertisements. In this embodiment, a content element manager is not implemented in FIGS. 3a through 3c. As a result, the amount of space used to display content elements in display area ‘B’ 306 exceeds the amount of space used by display area ‘A’ 304 to display primary information. Accordingly, context with the primary information contained in display area ‘A’ 304 is lost as the user moves the scroll bar 308 to view all of the content elements contained in display area ‘B’ 306.

Similarly, a content element manager is not implemented in FIGS. 3d through 3e. Display area ‘B’ 306 has now been implemented as a static display area to limit the number of displayed content elements. However, display area ‘A’ 304 now exceeds the space used by display area ‘B’ 306, with the result that the number of content elements displayed in display area ‘B’ 306 may have been unnecessarily limited.

FIG. 3f shows the implementation of a content element manager to optimize the number of content elements displayed in display area ‘B’ 306. In this and other embodiments, the content element manager determines the dimensions of display area ‘B’ 306. Then the content element manager determines the space required to display each content element. Calculations are then performed to determine the maximum number of content elements that will fit within the dimensions of display area ‘B’ 306. Once determined, the content elements are displayed in the display area ‘B’ 306 of the browser UI 302.

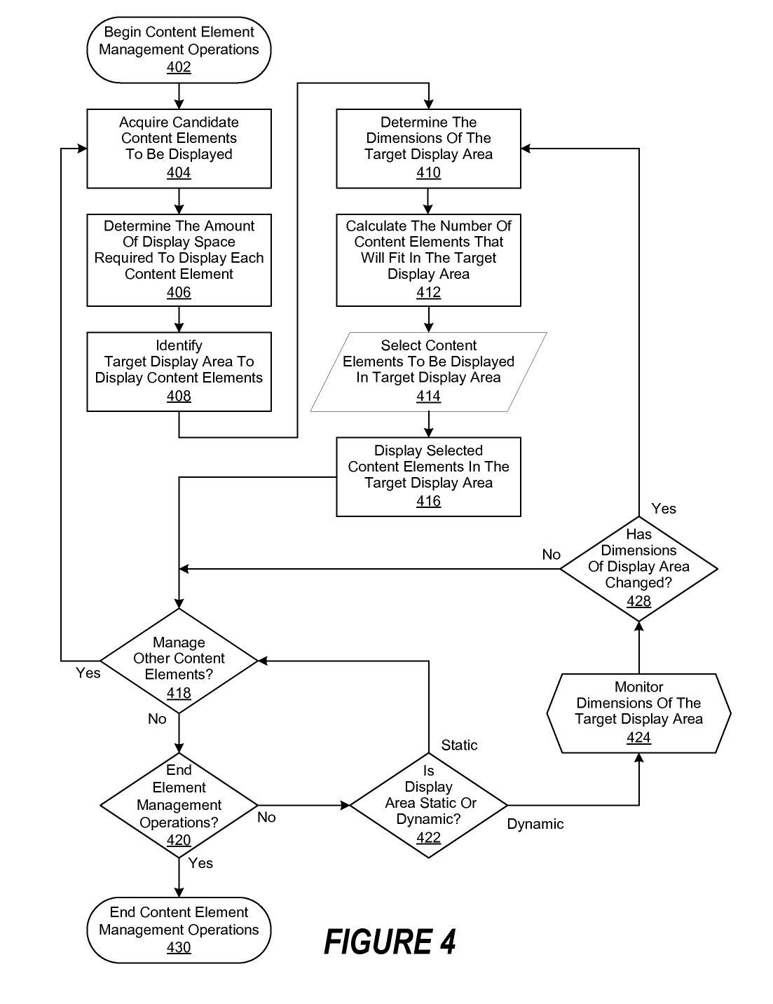

FIG. 4 shows a flowchart of a content element manager as implemented to optimize the display of content elements within a predetermined display area of a user interface (UI). In this embodiment, content element management operations are begun in step 402, followed by the acquisition of candidate content elements in step 404. In different embodiments, the content elements can be text, graphics, digitized photos, audio, video, or any content used for the conveyance of information of any type. The amount of display space required to display each content element is then determined in step 406. For example, the number of characters, and corresponding attributes such as font size or pixel measurements, are used to calculate the amount of space required to display a body of text. As exemplified in the following example, a Javascript method is implemented in one embodiment to calculate a content element's corresponding display space requirements by using its width and height as measured in pixels:

```
    <script type=”text/javascript”><!--
    content_element_client = “pub-2083499070704295”
    content_element_width = 728
    content_element_height = 90
    content_element_format = “728×90_as”
    content_element_type = “text_image”
    content_element_channel = “ “
    content_element_color_border = “6699CC”
    content_element_color_bg = “003366”
    content_element_color_link = “FFFFFF”
    content_element_color_text = “AECCEB”
    content_element_color_url = “AECCEB”
    //--></script>
    <script type=”text/javascript”
src=http://pagead2.contentsyndication.com/pagead/show_ads.js>
    </script>
```

In one embodiment, the amount of display space required for each content element, such as an advertising listing, is the same. In another embodiment, the amount of display space required for each content element, such as a Web page link, is different.

A target display area is then identified in step 408, followed by the determination of its dimensions in step 410. In one embodiment, at least one of the dimensions of the target display area is static. In another embodiment, at least one of the dimensions of the target display area is dynamic. Once the dimensions of the target display area have been determined, calculations are performed in step 412 to determine the maximum number of content elements that will fit within the target display area.

In one embodiment, a surrounding Javascript function is implemented with the Javascript method described above. The method, which comprises the width and height of the surround tag, is repeated within the function. As illustrated below, when the Javascript is placed in a td tag that has a height that equals 100%, the Javascript method will determine how much of the available space the inner Javascript would fill. If the Javascript fills 20%, then a FOR loop would be prompted to iterate five times. However, if the inner Javascript were to fill 30%, the FOR loop would only iterate three times as and iteration of four times would overflow the available display space.

```
    <table>
    <tr><td>Content Elements Fitted To Available Display Area</td>
    <td height=“100%”>
    <script type=“text/javascript”><!--
    content_element_client = “pub-2083499070704295”
    content_element_width = 728
    content_element_height = 90
    content_element_format = “728×90_as”
    content_element_type = “text_image”
    content_element_channel = “ “
    content_element_color_border = “6699CC”
    content_element_color_bg = “003366”
    content_element_color_link = “FFFFFF”
    content_element_color_text = “AECCEB”
    content_element_color_url = “AECCEB”
    //--></script>
    <script type=“text/javascript”
src=http://pagead2.contentsyndication.com/pagead/show_ads.js>
    </script>
    </td>
    </table>
```

The implementation of this embodiment requires knowledge of the actual pixel height of the target display area, which is provided by the browser. As an example, if the browser shows the height of the target display area to be 300 pixels, and the inner Javascript has a height of 90 pixels, then the inner Javascript can be iterated three times (3 iterations×90 pixels=270 pixels) to fit within the available height of 300 pixels. It will be apparent to those of skill in the art that the same method can be implemented using the width measurement instead of height.

Content elements are then selected for display in step 414. Skilled practitioners of the art will appreciate that there may be more candidate content elements than available space within the target display area. When this is the case, it is common to implement prioritization and weighting algorithms as part of the selection process. Regardless of how they are selected, the maximum number of selected content elements is displayed within the display area in step 416. A determination is then made in step 416 whether other content elements are to be managed. If so, the process is repeated, beginning with step 404. Otherwise, a determination is made in step 420 whether content element management operations are to be continued. If not, then content element management operations are ended in step 430.

Otherwise, it is determined in step 420 whether the display area is static or dynamic. If it is determined that the display area is static, then the process is repeated, beginning with step 418. However, if it is determined in step 422 that the display area is dynamic, then the dynamic display area is monitored in step 424. For example, the dimensions of a primary display area may change, such as when additional content is presented within a user's UI. Such a change could result in a corresponding change in the dimensions of the display area containing the content elements. As a result, additional, or less, space may be available for the display of content elements. If it is determined in step 428 that the dimensions of a dynamic display area have changed, then the process is repeated, beginning with a determination of the dimensions of the display area in step 410. Otherwise, the process is repeated, beginning with step 418.

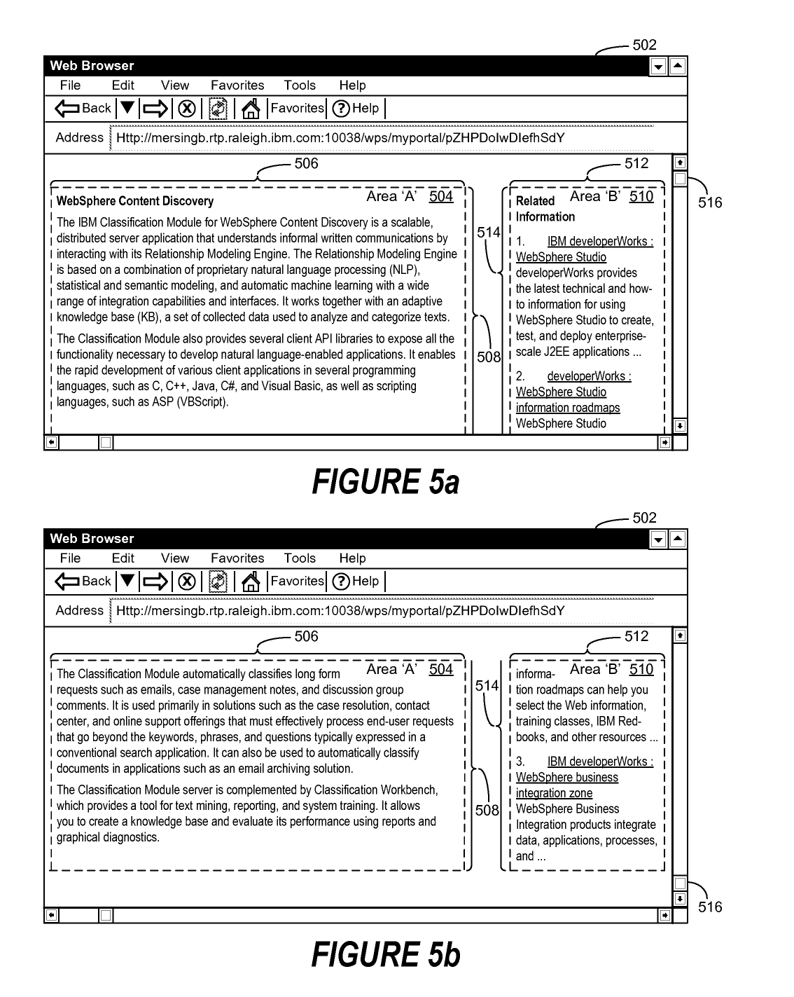

FIGS. 5a-b show a simplified browser user interface (UI) 502 as implemented with a content element manager to optimize the display of content elements in a static display area. In this embodiment, the browser UI 502 comprises static display area ‘A’ 504 and static display area ‘B’ 510. As described in greater detail herein, content requests are typically submitted by a browser to a content server. In response, the content server accesses content elements, which are then retrieved and sent for display within static display area ‘A’ 504 and static display area ‘B’ 510 in the browser UI 502. Static display areas ‘A’ 504 and ‘B’ 510 respectively comprise dimensions for width 506, 512 and length 508, 514. In one embodiment, static display area ‘A’ 504 is implemented as a primary information display area and static display area ‘B’ 510 is implemented to display a plurality of content elements such as links to related Web pages. As illustrated in FIGS. 5a and 5b, the contents of static display areas ‘A’ 504 and ‘B’ 510 can be viewed by moving the scroll bar 516 through a user gesture.

In this embodiment, information content is returned for display within static display area ‘A’ 504 and candidate content elements are acquired for display in static display area ‘B’ 510. As described in greater detail herein, the amount of display space required to display each content element is determined by the content element manager. In one embodiment, the amount of display space required for each content element, such as an advertising listing, is the same. In another embodiment, the amount of display space required for each content element, such as a Web page link, is different. The content element manager then determines the width 512 and length 514 dimensions of static content display area ‘B’ 510. Calculations are performed to determine the maximum number of content elements that can be displayed within the width 512 and length 514 dimensions of static content display area ‘B’ 510. Once determined, content elements are selected and displayed in the static content display area ‘B’ 510.

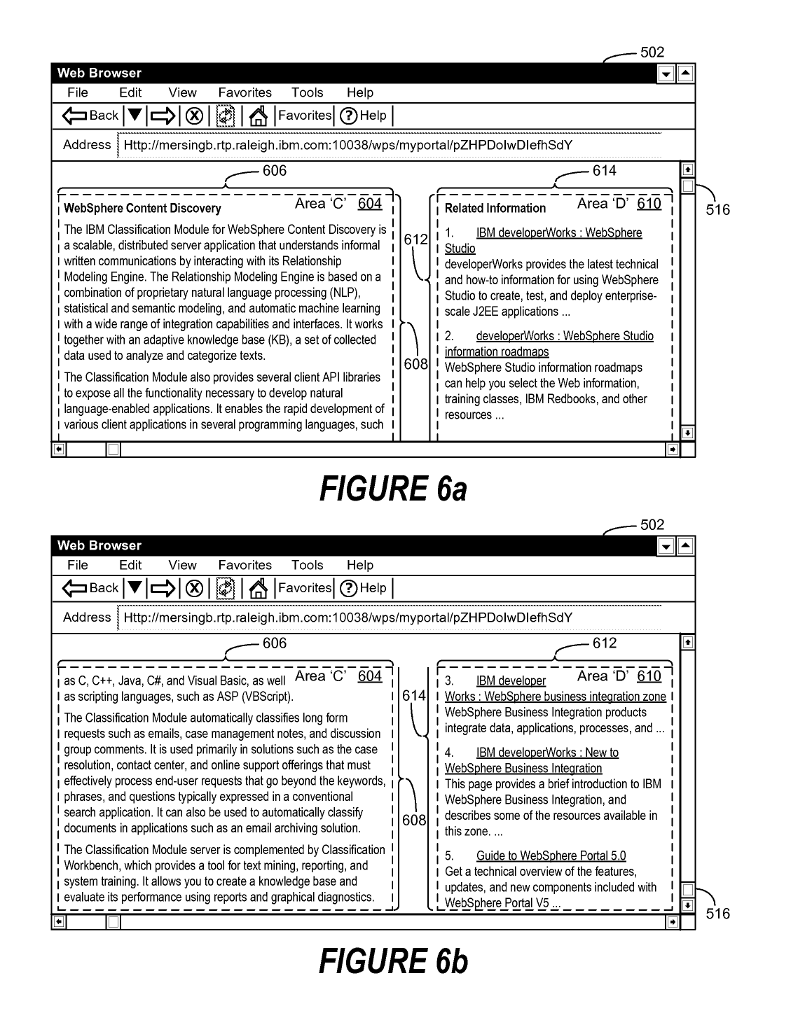

FIGS. 6a-b show a simplified browser user interface (UI) 502 as implemented with a content element manager to optimize the display of content elements in a dynamic display area. In this embodiment, the browser UI 502 comprises dynamic display area ‘C’ 604 and dynamic display area ‘D’ 612. As described in greater detail herein, content requests are typically submitted by a browser to a content server. In response, the content server accesses content elements, which are then retrieved and sent for display within dynamic display area ‘C’ 604 and dynamic display area ‘D’ 610 in the browser UI 502. Dynamic display areas ‘C’ 604 and ‘D’ 610 respectively comprise dimensions for width 606, 612 and length 608, 614. In one embodiment, dynamic display area ‘C’ 604 is implemented as a primary information display area and dynamic display area ‘D’ 610 is implemented to display a plurality of content elements such as links to related Web pages. As illustrated in FIGS. 6a and 6b, the contents of dynamic display areas ‘C’ 604 and ‘D’ 610 can be viewed by moving the scroll bar 516 through a user gesture.

In this embodiment, information content is dynamically generated and returned for display within dynamic display area ‘C’ 604. Candidate content elements are likewise dynamically generated and then acquired for display in dynamic display area ‘D’ 610. As described in greater detail herein, the amount of display space required to display each content element is determined by the content element manager. In one embodiment, the amount of display space required for each content element is the same. In another embodiment, the amount of display space required for each content element is different. The content element manager then determines the width 612 and length 614 dimensions of static content display area ‘D’ 610. Calculations are performed to determine the maximum number of content elements that can be displayed within the width 612 and length 614 dimensions of dynamic content display area ‘D’ 610. Once determined, content elements are selected and displayed in the dynamic content display area ‘D’ 610.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of skill in the art without departing from the scope and spirit of the invention. The embodiment was chosen and described in order to best explain the principles of the invention and the practical application, and to enable others of skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for managing the display of content comprising:
acquiring a plurality of content objects;
determining an amount of display space required to display each of the content objects;
identifying a display area to display the plurality of content objects;
determining dimensions of the display area;
calculating a maximum amount of content object information that can fit within the dimensions of the display area; and
displaying the plurality of content objects, the plurality of content objects being displayed not exceeding the maximum amount of content information that can fit within the dimensions of the display area, the displaying optimizing display of the plurality of related content objects within the display area.

2. The method of claim 1, wherein the amount of display space each of the plurality of content objects occupies is the same.

3. The method of claim 1, wherein the amount of display space each of the plurality of content objects occupies is different.

4. The method of claim 1, wherein at least one of the dimensions of the display area is static.

5. The method of claim 1, wherein at least one of the dimensions of the display area is dynamic.

6. The method of claim 1, wherein the state of the display area is monitored to determine if there is a change in its dimensions, the maximum number of content objects subject to change as the dimensions of the display area change.

7. A system comprising:
a processor;
a data bus coupled to the processor; and
a computer-usable medium embodying computer program code, the computer-usable medium being coupled to the data bus, the computer program code for managing the display of content and comprising instructions executable by the processor and configured for:
acquiring a plurality of content objects;
determining an amount of display space required to display each of the content objects;
identifying a display area to display the plurality of content objects;
determining dimensions of the display area;
calculating a maximum amount of content object information that can fit within the dimensions of the display area; and
displaying the plurality of content objects, the plurality of content objects being displayed not exceeding the maximum amount of content information that can fit within the dimensions of the display area, the displaying optimizing display of the plurality of content objects within the display area.

8. The system of claim 7, wherein the amount of display space each of the plurality of content objects occupies is the same.

9. The system of claim 7, wherein the amount of display space each of the plurality of content objects occupies is different.

10. The system of claim 7, wherein at least one of the dimensions of the display area is static.

11. The system of claim 7, wherein at least one of the dimensions of the display area is dynamic.

12. The system of claim 7, wherein the state of the display area is monitored to determine if there is a change in its dimensions, the maximum number of content objects subject to change as the dimensions of the display area change.

13. A computer-usable medium embodying computer program code, the computer program code comprising computer executable instructions configured for:
acquiring a plurality of content objects;
determining an amount of display space required to display each of the content objects;
identifying a display area to display the plurality of content objects;
determining dimensions of the display area;
calculating a maximum amount of content object information that can fit within the dimensions of the display area; and
displaying the plurality of content objects, the plurality of content objects being displayed not exceeding the maximum amount of content information that can fit within the dimensions of the display area, the displaying optimizing display of the plurality of content objects within the display area.

14. The computer usable medium of claim 13, wherein the amount of display space each of the plurality of content objects occupies is the same.

15. The computer usable medium of claim 13, wherein the amount of display space each of the plurality of content objects occupies is different.

16. The computer usable medium of claim 13, wherein at least one of the dimensions of the display area is static.

17. The computer usable medium of claim 13, wherein at least one of the dimensions of the display area is dynamic.

18. The computer usable medium of claim 13, wherein the state of the display area is monitored to determine if there is a change in its dimensions, the maximum number of content objects subject to change as the dimensions of the display area change.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.
